(19) United States
(12) Patent Application Publication
(10) Pub. No.: US 2021/0076657 A1
(43) Pub. Date: Mar. 18, 2021

(54) INSECT TRAP

(71) Applicant: WITASEK Pflanzenschutz GmbH, Feldkirchen (Ktn.) (AT)

(72) Inventor: Peter WITASEK, Feldkirchen (AT)

(21) Appl. No.: 17/014,317

(22) Filed: Sep. 8, 2020

(30) Foreign Application Priority Data
Sep. 12, 2019 (AT) A 292/2019

(51) Int. Cl. A01M 1/04

(52) U.S. Cl. CPC A01M 1/04; A01M 2200/01

(57) ABSTRACT

On its outside, an insect trap has at least one black area or is completely black. Above a temperature that lies between 25° C. and 40° C., the black color changes into a color that is preferred by the insect pest that is to be captured. The color change takes place either by having an initially black coating be see-through and the color that is provided under the coating and is preferred by the insect pest be visible, or by the black color of the insect trap or its black area changing into a color that is preferred by the insect pest that is to be captured.

The invention relates to an insect trap, to which insects are attracted and in particular in which insects are captured as well as optionally killed.

Such insect traps, which are used to attract, capture and/or kill insect pests, are known in various embodiments.

As examples, the following known insect traps can be mentioned: slotted traps, bark beetle slotted traps, dry or wet traps with impact surfaces, segmented funnel traps, lantern traps, sticky traps with three-sided, sticky prisms, wing traps-sticky traps, and pyramidal-web insect traps. Examples of insect traps that are considered here are known from AT 513 518 B1.

Slotted traps are known from, for example, DE 195 15 454 A1 and EP 1 900 280 A1.

In order to improve the luring of insects (insect pests), neurotransmitters (semiochemicals, such as, e.g., pheromones) are frequently assigned to known insect traps.

There is a problem in that neurotransmitters by themselves are not sufficient to adequately attract insects with known insect traps.

It is also known to attract insect pests not only with neurotransmitters but also with direct light sources. In this case, the insects are attracted to a trap system and/or an insect-killing site (e.g., insecticide web). In the case of a trap system, the insects are captured in the insect trap (e.g., slotted traps, segmented funnel traps, sticky traps, lantern traps, web traps, light traps, etc.), whereby killing insect traps are also called attract-and-kill systems (e.g., insecticide webs and insecticide traps).

The luring of insects, such as, e.g., bark beetles, with neurotransmitters (semiochemicals or pheromones, allelochemicals, kairomones, allomones) that act in a way such as to attract the insects, supplemented by a system that significantly increases attractiveness to insect pests and thus—depending on the application—the capture in the trap system or the effect of attract-and-kill systems, is also known.

It is known from M. A. Khanzada et al., “Influence of Different Colours on the Effectiveness of Water Pan Traps to Capture Insects in Mustard Ecosystem” in the International Journal of Biology and Biotechnology 13 (2): 273-277, 2016, that the color of insect traps has an effect on the capture rate. Yellow, white, green and black insect traps in the form of pans filled with 5% aqueous formalin solution were used.

M. Paraschiv et al., “The Effect of Intercept Trap Color on Ips Typographus Captures” in the Bulletin of Transilvania University of Brasov, Vol. 5 (54) No. 1-2012, report that Ips typographus (spruce bark beetles) are especially attracted by dark insect traps, for example brown and black insect traps, since the latter have a higher temperature when exposed to solar radiation.

A. S. Packard, “Color Preference in Insects” in the Journal of the New York Entomological Society, Vol. 11, No. 3 (September, 1903), pp. 132-137, describes that insects prefer certain colors.

It has been observed that insect pests, such as, for example, bark beetles (spruce bark beetles), in most cases bore into the host plant on its side that faces away from the sun. The reason for this is the very strong infrared radiation that radiates from the hot, sun-side surface of the host plants and acts to repel insects.

Then again, infrared radiation is attractive to insect pests to a certain extent, whereby, however, a bark surface that is too hot signals to the insect pest, in particular the bark beetle, that its larvae cannot develop optimally here (excessive temperature).

In order to improve the luring of insect pests, such as, for example, bark beetles, it is also known to provide insect traps with a black surface. However, this has the drawback that the black surface heats with solar radiation, and the above-mentioned repelling action has a greater effect on insect pests, in particular bark beetles, so that the desired insect-pest-attracting effect is limited.

From EP 1 832 167 A2, it is known to enhance a substrate for the active ingredient layer of an insect trap with thermochromic color for the purpose of attracting insects. How this is to be achieved is not disclosed in EP 1 832 167 A2.

The object of the invention is to increase the attractiveness of insect traps—regardless of design.

This object is achieved with an insect trap that has the features of Claim 1.

Preferred and advantageous configurations of the invention are the subject matter of the subclaims.

Within the framework of the invention, an embodiment of the insect traps is taken into consideration, in which at least one part of the wall that forms the outside of the insect traps consists of a material that contains thermochromic pigments. In this embodiment, the portion of the outside is black below a certain temperature and colored above the certain temperature. The color is in particular a color that is attractive to the insect pest that is to be captured.

In a second embodiment that is taken into consideration within the framework of the invention, the outside of the insect trap has at least one thermochromic coating in places, which is black below a certain temperature and permeable to light above the certain temperature, so that the outside of the insect trap, which lies below the coating and has a color that is attractive to the insect pest that is to be captured, is visible at least to the insect pest that is to be captured.

Since, in the case of the insect traps according to the invention at least in (selected) areas, the outside thereof or the entire outside of the insect traps above a certain temperature has a color that is attractive to the insect pest that is to be captured, and since the color corresponds to the color of a host plant that is preferred by the insect pest that is to be captured or to a preferred residence, a two-fold advantageous effect is produced. The insect trap that is black at least in places, i.e., below the selected (specific) temperature, is heated initially in a desirable way and is attractive to insect pests. Above the selected temperature, the insect trap has a color that is attractive to the insect pest that is to be captured. In addition, the wall of the insect trap that forms the outside is no longer excessively heated when exposed to solar radiation and therefore provides less IR radiation, since the wall now has a color other than black, and the color reflects the sunlight more strongly than the black outside (wall) of the insect trap.

The described effect of the change in color at least in areas of the outside, in particular the wall, of the insect trap can be created in various ways. In one embodiment, a thermochromic dye is contained in the material that forms the outside of the insect trap, which dye—above the specific temperature—changes its color reversibly from black into a color that is attractive to the insect pest that is to be captured.

In another embodiment, the outside of the insect trap has a color that acts in a way such as to attract the insect pest that is to be captured. In addition, in this embodiment, a coating is provided on the outside of the insect trap, which coating is black below the selected, specific temperature and is reversibly permeable to light above this temperature.

Here, the term “a color that is attractive to the insect pest” is defined in particular as a color that corresponds at least to a large extent to the color of a preferred host plant or a preferred residence of the insect pest that is to be captured, i.e., a color that the insect that is to be captured sees (well) and that is (especially) attractive to the insect that is to be captured.

Since, in the case of the insect trap according to the invention in one embodiment, the coating that is initially black and in particular opaque is permeable to light above a certain temperature, the undesirable increase in temperature—and thus the enhanced emission of infrared radiation—does not occur.

Within the framework of the invention, it is provided, for example, that the area of the insect trap that is black below the specific temperature or the coating of the insect trap that is black in places at a temperature of between 25° C. and 40° C., in particular at a temperature of between 29° C. and 31° C., is permeable (see-through, transparent or translucent) to light, in particular to light that is seen by the insects that are to be captured, and strikes a color of the insect trap or is visible, which attracts/lures the insect. This is achieved, for example, in such a way that below the coating that is black and permeable to light above a certain temperature, the insect trap has a color that is attractive to the insect. With bark beetles (spruce bark beetles), this is, for example, the color (light-) brown.

In the case of the insect trap according to the invention, the advantageous effect occurs that on normal days at moderate temperatures and moderate solar radiation, the black insect trap is highly attractive to insect pests based on its higher infrared radiation, so that a high capture rate is achieved. When the temperature of the surface of the insect trap increases above a certain value, for example above 31° C., in the one embodiment of the insect trap according to the invention, the black outside of the insect trap takes on the color that attracts the insect pest, or in another embodiment, the black coating is permeable to light, so that not only the high infrared radiation is reduced, but also the color of the insect trap that is present below the previously black—but now light-permeable—coating becomes visible.

Within the framework of the invention, it is especially preferred that at least parts (areas) of the insect trap above the specific temperature have a color that is especially attractive to the insect pest that is to be captured in each case. In another embodiment, the insect trap is provided at least partially with a coating that is black and in particular opaque below a certain temperature and is permeable to light above the certain temperature. This coating can be, for example, a thermochromic lacquer.

It is preferred that the outside of the insect trap or its coating be black again and in particular opaque below a certain temperature. The property of the insect trap to change its color from black into a color that attracts the insect pest and the property of the coating to be permeable to light are thus reversible. The specific temperature above which the outside of the insect trap is no longer black but rather colored, or the coating that is applied there is no longer black but rather is permeable to light, is selected based on the insect pest that is to be captured. This temperature is selected based on the insect pest that is to be lured and captured and is usually between 25° C. and 40° C., in particular between 29° C. and 31° C. In the example of the large spruce bark beetle, the temperature is between 29° C. and 31° C.

The temperature above which the outside of the insect trap changes its color or the black coating is permeable to light, on the one hand, and the color of the insect trap or the color below the black coating, on the other hand, can be selected in such a way that for a certain kind/type of insect (pest) that is to be captured, the insect trap remains attractive not only at low temperatures, but also at higher temperatures.

Examples of this are:

1. Bark Beetles (Spruce Bark Beetles):
The black coating is permeable to light above a temperature of the wall of the insect trap of 31° C., so that the “light brown” color of the insect trap that is provided below the black coating can be seen.

2. Bark Beetles (Spruce Bark Beetles):
The black color of the material of the insect traps changes at least in places above a temperature of 31° C. to “light brown.”

Below, examples of colors that are especially attractive to insects are cited:

Bark beetle: Light brown to brown

Grass leaf roller: Blue-green

Swift moth: Yellow-orange

Geometer moth: Blue-green

House moth: Green

It has been shown that insect traps that have one such color at least in places when they have (at least in places) a temperature that is above the specific temperature are especially advantageous and are especially effective in capturing the desired insect.

In summary, an embodiment of the invention can be described as follows:

On its outside, an insect trap has at least one black area or is completely black. Above a temperature that is between 25° C. and 40° C., the black color changes into a color that is preferred by the insect pest that is to be captured. The color change takes place either by having an initially black coating be see-through and the color that is provided below the coating and is preferred by the insect pest be visible, or by the black color of the insect trap or its black area changing into a color that is preferred by the insect pest that is to be captured.

1. Insect trap that is black at least in places on an outside, wherein the outside has a color that is reversible above a certain temperature, which color corresponds at least to a large extent to the color of a host plant or a preferred residence of the insect pest that is to be captured.

2. The insect trap according to claim 1, wherein the insect trap has a black coating at least in places on an outside and wherein the black coating is permeable to light above a certain temperature.

3. The insect trap according to claim 1, wherein the outside of the insect trap or the coating of the insect trap contains thermochromic pigments.

4. The insect trap according to claim 2, wherein the insect trap has a color below the black coating, which color corresponds at least to a large extent to the color of a host plant or a preferred residence of the insect pest that is to be captured.

5. The insect trap according to claim 1, wherein the outside of the insect trap above a temperature of between 25° C. and 40° C., has a color that corresponds at least to a large extent to the color of a host plant or a preferred residence of the insect pest that is to be captured.

6. The insect trap according to claim 1, wherein the black coating is permeable to light above a temperature of between 25° C. and 40° C.

7. The insect trap according to claim 1, wherein the black coating is permeable to light above a certain temperature for a wavelength of the light that is seen by the insect that is to be captured.

8. The insect trap according to claim 1, wherein the black coating is see-through, transparent, or at least translucent above a certain temperature.

9. The insect trap according to claim 1, wherein the outer wall of the insect trap at least in places consists of a material that is black, and that above a certain temperature has a color that corresponds at least to a large extent to the color of a host plant or a preferred residence of the insect pest that is to be captured.

10. The insect trap according to claim 9, wherein the material of the wall of the insect trap contains at least one thermochromic pigment.

11. The insect trap according to claim 9, wherein the outer wall of the insect trap above a temperature of between 25° C. and 40° C., has a color that corresponds at least to a large extent to the color of a host plant or a preferred residence of the insect pest that is to be captured.

12. The insect trap according to claim 2, wherein the outside of the insect trap or the coating of the insect trap contains thermochromic pigments.

13. The insect trap according to claim 3, wherein the insect trap has a color below the black coating, which color corresponds at least to a large extent to the color of a host plant or a preferred residence of the insect pest that is to be captured.

14. The insect trap of claim 5, wherein the outside has a temperature between 29° C. and 31° C.

15. The insect trap of claim 6, wherein the black coating is permeable to light above a temperature of between 29° C. and 31° C.

16. The insect trap of claim 11, wherein the outer wall of the insect trap above a temperature of between 29° C. and 31° C.

17. The insect trap according to claim 2, wherein the outside of the insect trap above a temperature of between 25° C. and 40° C., has a color that corresponds at least to a large extent to the color of a host plant or a preferred residence of the insect pest that is to be captured.

18. The insect trap according to claim 3, wherein the outside of the insect trap above a temperature of between 25° C. and 40° C., has a color that corresponds at least to a large extent to the color of a host plant or a preferred residence of the insect pest that is to be captured.

19. The insect trap according to claim 4, wherein the outside of the insect trap above a temperature of between 25° C. and 40° C., has a color that corresponds at least to a large extent to the color of a host plant or a preferred residence of the insect pest that is to be captured.

20. The insect trap according to claim 2, wherein the black coating is permeable to light above a temperature of between 25° C. and 40° C.
